(19) United States
(12) Patent Application Publication
(10) Pub. No.: US 2001/0034223 A1
(43) Pub. Date: Oct. 25, 2001

(54) Method and system for providing location dependent and personal identification information to a public safety answering point

(75) Inventors: Christian J. Rieser, Middletown, MD (US); Jerome A. Gansman, Silver Spring, MD (US); Gilmer L. Blankenship, Washington, DC (US); Steven A. Tretter, Silver Spring, MD (US); Adrianos Papamarcou, Washington, DC (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: University of Maryland, College Park.

(21) Appl. No.: 09/838,318

(22) Filed: Apr. 20, 2001

Related U.S. Application Data
(63) Continuation of application No. PCT/US99/24477, filed on Oct. 22, 1999.
(60) Provisional application No. 60/105,175, filed on Oct. 22, 1998.

(51) Int. Cl. H04M 11/00

(52) U.S. Cl. 455/404; 455/456; 455/67.1

(57) ABSTRACT

A method and system are provided for sending location dependent and personal identification information to a public safety answering point. Base stations for receiving a transmission packet signal having a transmitter identification number are located throughout an area where personal security coverage is desired. Whenever a personal security transmitter is activated, it is received by one or more base stations. Each base station has a signal receiving unit for receiving a transmission packet signal and a signal processing unit for processing a transmission packet signal and generating a base station packet. Base station packets contain both a transmitter identification number and location information about the activated transmitter. After a base station packet is generated, it is sent to a command center for processing. If a valid base station packet is received at a command center, information contained in the base station packet is used to determine the closest base station to the activated transmitter and to retrieve personal identification information about the person to whom the transmitter was issued. This location and personal identification information is then displayed at the command center or public safety answering point.

### CROSS REFERENCE TO RELATED APPLICATIONS

This application is a continuation of pending International Application No. PCT/US99/24477, filed Oct. 22, 1999, which claims the benefit of U.S. Provisional Patent Application No. 60/105,175, filed Oct. 22, 1998, both of which are incorporated herein by reference in their entireties.

### BACKGROUND OF THE INVENTION

1. Field of the Invention

The present invention relates generally to a communications system. More particularly, it relates to a college campus security communications system. Even more particularly, it relates to a college campus security communications system for providing location and personal identification information to a public safety answering point.

2. Background Art

Personal security at college campuses is an increasingly important matter to students, parents, and college officials everywhere. The number of violent crimes, such as rape, robbery, and aggravated assault, which are occurring on college campuses these days has alarmed everyone. In particular, it has alarmed those officials who are responsible for campus safety, even at those campuses where violent crimes are not being reported, and it has motivated many of them to take concrete steps to improve personal security on their campuses.

One concrete step taken by many of these officials has been to increase the number of campus police. While this is an important first step to improving personal security, campus police must still be alerted to the existence of a problem before they can respond. The key to effective personal security therefore is an individual's ability to quickly alert campus police that they are in need of help. For campus police to respond quickly and effectively, however, they must know the location and identification of the person who is in need of help.

What is needed to improve personal security at college campuses and elsewhere therefore is a small handheld device that can be quickly and easily activated by an individual in need of help. This device should provide the police or other responders with at least the individual's location and personal identification information.

### BRIEF SUMMARY OF THE INVENTION

The present invention provides a method and system for providing location and personal identification information to a public safety answering point. In one embodiment of the present invention, base stations for receiving a transmission packet signal having a transmitter identification number are located throughout an area where personal security coverage is desired. Base stations may be in a fixed location or they may be mobile. When a personal security transmitter is activated, it is received by one or more base stations. Each base station has a signal receiving unit for receiving a transmission packet signal and a signal processing unit for processing transmission packet signals and generating a base station packet. A base station packet contains both a transmitter identification number and location information.

In one embodiment of the present invention, the signal processing unit of a base station is a microprocessor, and each base station packet is transmitted from the base station to a command center using a telephone and a modem. In this embodiment, each base station packet sent to a command center has a time stamp and power information that can be used to determine which base station was closest to the activated transmitter.

In an embodiment of the present invention, base station packets are received at a command center and processed by a microprocessor running a software application. In this embodiment, the software application first determines whether a valid base station packet was received. If a valid base station packet was received, the software application then determines the identification number of the activated transmitter and uses this number to retrieve personal identification information about the person to whom the transmitter was issued from a data base. In addition, the software application also determines the closest base station to the activated transmitter. Both the closest base station to the activated transmitter and the personal identification information retrieved from the data base are displayed on a computer terminal at the command center.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a diagram of a relationship between a transmitter, base stations, and a command center according to an embodiment of the present invention.

FIGS. 2A and 2B are a flow chart of a method for providing location and personal identification information to a public safety answering point according to an embodiment to the present invention.

FIG. 3 is a flow chart of a routine for determining a base station closest to an activated transmitter according to an embodiment of the present invention.

FIG. 4 is a block diagram of a system that can implement the present invention.

FIG. 5 is a block diagram of a base station according to an embodiment of the present invention.

FIG. 6 is a block diagram of a base station according to an embodiment of the present invention.

FIG. 7 is an example computer system that can be used to implement a command center according to the present invention.

FIGS. 8A-8H are examples of some graphical user interfaces that can be displayed to a user of the present invention located at a command center.

The present invention is described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

Overview and Terminology

The present invention provides a method and system for providing location dependent and personal identification information to a public safety answering point.

The term “public safety answering point” or “command center” refers to a place where a call for assistance may be received and action taken to either respond to the call or direct a response to the call. A public safety answering point can include, but is not limited to, a college campus police station, a private security office, or a local community police station. The terms “public safety answering point” and “command center” are used interchangeably.

The term “base station” refers to a location where personal security transmitter signals (also called beacon signals) are received and processed. Base stations are located throughout an area where personal security coverage is desired. Base stations may be in a fixed location, or they may be mobile. Each base station has both a signal receiving unit and a signal processing unit.

The term “base station packet” refers to the packet of information sent from a base station to a command center. A base station packet contains both transmitter identification data and location data.

The terms “personal security transmitter,” “transmitter,” “beacon,” or “handset” refer to a portable transmitter, which sends a transmission packet signal upon activation. A “personal security transmitter,” “transmitter,” “beacon,” or “handset” may contain a receiver or transceiver, which receives a transmission signal. The terms “personal security transmitter,” “transmitter,” “beacon,” and “handset” are used interchangeably.

The term “transmission packet signal” refers to the signal generated by a personal security transmitter when activated. A transmission packet signal includes transmitter identification data.

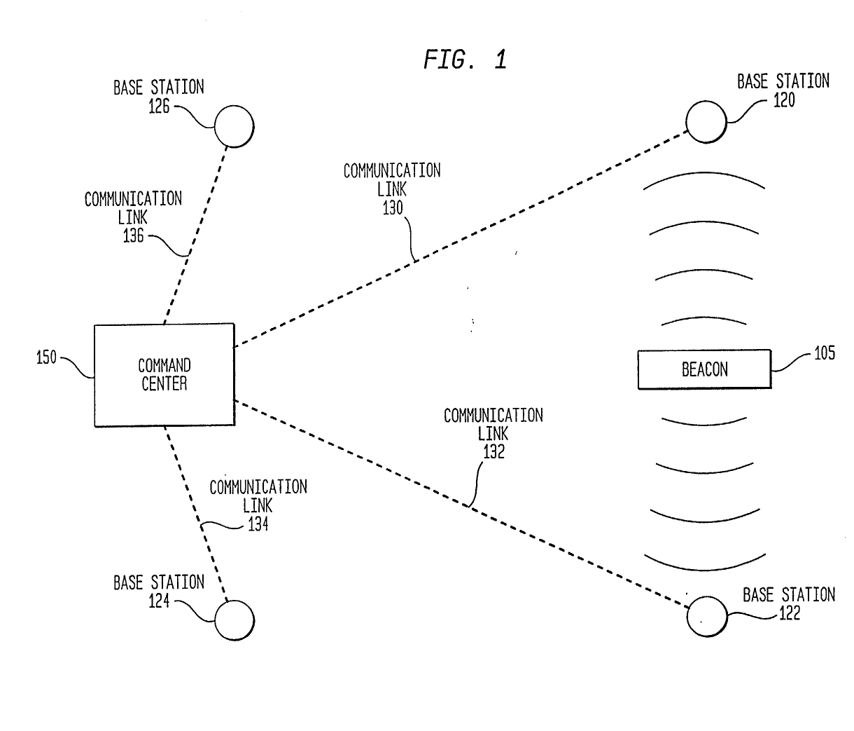

FIG. 1 shows the relationship between a personal security transmitter 105, base stations 120-126, communication links 130-136, and a command center 150.

In one example, personal security transmitter 105 sends a transmission signal packet upon activation, which is received by base stations 120 and 122. Base stations 120 and 122 receive and process the transmission signal packet. Base station 120 generates a base station packet and transmits it via communication link 130 to command center 150. Base station 122 generates abase station packet and transmits it via communication link 132 to command center 150. When a base station packet is received at command center 150, it is processed and used among other things to alert personnel at the command center or in the field that a call for assistance has been received.

Method for Providing Location and Personal Identification Information to a Public Safety Answering Point

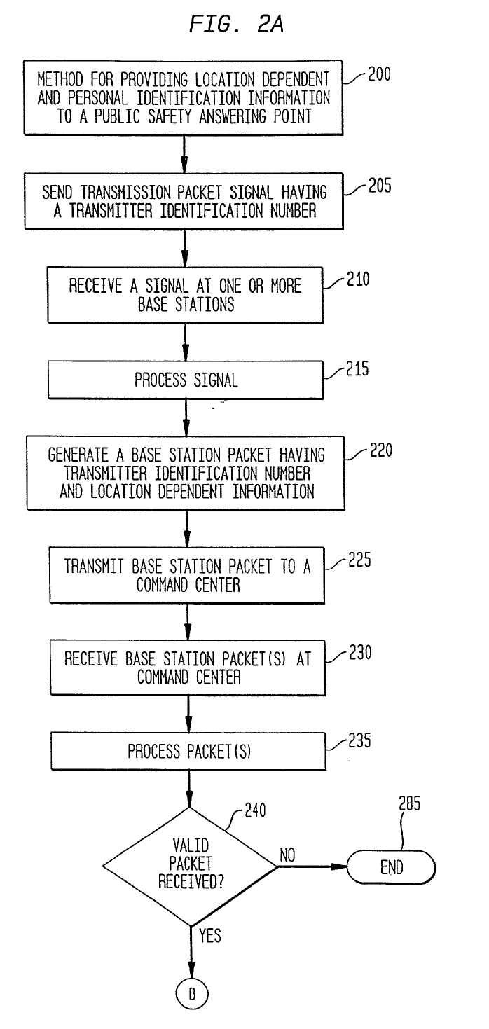

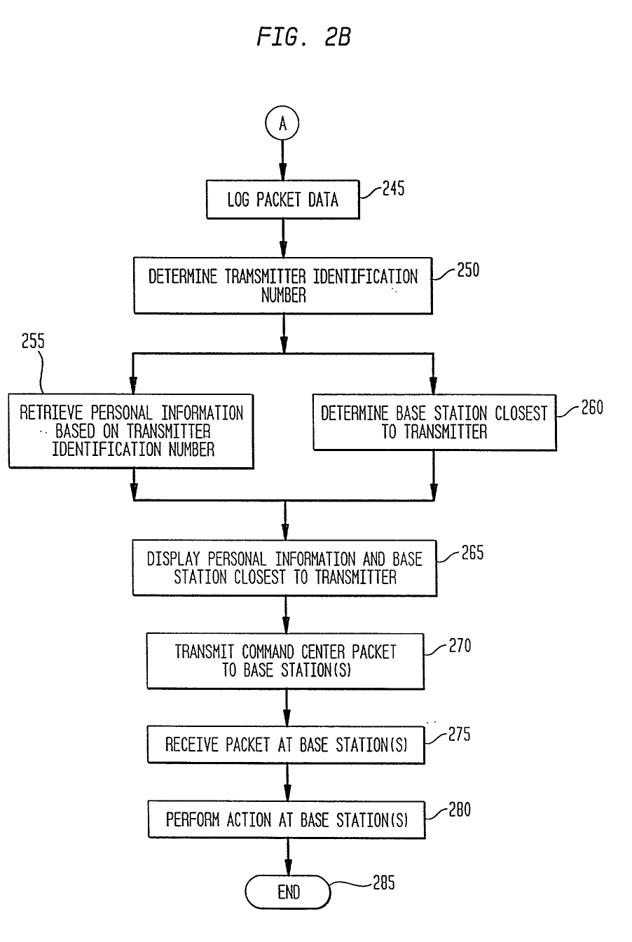

FIGS. 2A and 2B are a flow chart of a method for providing location and personal identification information to a public safety answering point 200 according to an embodiment to the present invention. Method 200 comprises steps 205-285. For clarity, method 200 is described with reference to the example system of FIG. 1

Referring to FIG. 2A, method 200 starts at step 205 with the activation of personal security transmitter 105. Upon activation, personal security transmitter 105 send a transmission packet signal having a transmitter identification number. The transmitter identification number sent by personal security transmitter 105 is a unique number that can be used to identify the transmitter sending the transmission packet signal. Although transmitter identification numbers are unique in a particular security area or region, it is possible to reuse transmitter identification numbers in a different security area or region. In an embodiment of the present invention, binary phase shift keying is employed to send information in a radio frequency carrier wave from a transmitter to a base station. It would be known to a person skilled in the relevant art(s), however, that any modulation scheme can be employed to send information in a radio frequency carrier wave from a transmitter to a base station, and the present invention is not limited to employing binary phase shift keying.

In step 210, the transmission packet signal sent in step 205 is received by one or more base stations 120-126. Each receiving base station 120-126 then processes the received transmission packet signal in step 215. In an embodiment of the present invention, the transmission packet signal sent by the personal security transmitter contains a header, a transmitter identification number, a transmission frame number, a version number, and a error checking number. Upon receipt of a transmission packet signal, the signal receiving unit of a base station separates the packet information of the signal from its radio frequency carrier wave. The packet information is then provided to a signal processing unit for processing. The signal may be processed to verify that a valid transmission packet signal has been received.

In step 220, a base station packet is generated by a signal processing unit. A base station packet contains some or all of the information contained in a transmission packet signal plus additional location dependent information generated by the signal processing unit of a base station. Types of location dependent information that may be included in a base station packet are time of arrival or time difference of arrival information and/or power information.

Time of Arrival (TOA) and Time Difference of Arrival (TDOA) Information

Both TOA and TDOA information can be used to determine transmitter location. Although TOA and TDOA information are similar, there are some important differences in implementation.

TOA information requires that both transmitters and base stations have synchronized clocks. In TOA methods, a time stamp is attached to a signal by a transmitter when it is transmitter. A second time stamp is added to the signal information when it is received at a bases station. Using these two time stamps, one can determine how long it took a signal to propagate from a transmitter to a base station. If the signal propagation time is known for three or more base stations, the transmitter's position can be calculated.

Implementing a TDOA method is a different. In a TDOA method, all of the base stations must have synchronized clocks, but the transmitters do not need a synchronized clock. In a TDOA method, each base station knows when it received a signal based on its synchronized clock. When a signal arrives at a base station, it is given a time stamp. The time stamps from each receiving base station are then sent to a command center where an algorithm is used to determine a transmitter's location.

There are many ways to produce a time stamp, such as using a GPS receiver and local synchronized clocks, which would be known to a person skilled in the relevant art(s) given this description. A more detailed discussion of how to implemented a GPS based system is provided below.

Power Information

Power information may also be used to determine transmitter location. Power information is information about the power of a signal when it is received at a base station. The farther a signal travels from its source of origin, the greater it is attenuated. Therefore, if the power-of a transmitted signal is determined when it arrives at various base stations, this information can be input into a propagation model software application, which can then be used to estimate the location of the transmitter that sent the signal. The power of a signal may be Act determined by integrating a received signal during a finite period of time using a typical integrating circuit and a typical counting circuit that would be known to a person skilled in the relevant art(s).

Other types of location information, which may be included in a base station packet, will also be known to a person skilled in the relevant art(s) given this description. A more detailed discussion of different types of location information that can be used to determine the location of a transmitter is provided below.

In step 225, the base station packet generated in step 220 is transmitted to command center 150. In one embodiment of the present invention, the base station packet sent to a command center contains a base station identification number, a transmitter identification number, a number representing the power of the received transmission packet signal, a number representing the time when the transmission packet signal was received, a transmission frame number, and a version number. Other information that might be usefully in helping a public safety answering point respond to a call for assistance can also be included in a base station packet signal.

In step 230, one or more base station packets are received at command center 150. In step 235, these received base station packets are processed. In an embodiment of the present invention, base station packets are sent to a command center using a modem and a commercial telephone line. In this embodiment, steps 230 and 235 are performed by a modem located at the command center. In general, any type of communication interface or protocol can be used, however. Exactly how the base station packets are received and processed in steps 230 and 235 will depend on the means of transmission used by the base stations to send the base station packets to the command center. Several means that might be used to transmit and receive base station packets would be known by a person skilled in the relevant art(s) given this description.

In step 240, a processing unit, for example a computer or microprocessor located at command center 150, determines whether one or more valid base station packets have been received. If a valid base station packet has not been received, control passes to step 285 and the method ends. If a valid base station packet has been received, then control passes to step 245.

There are several reason why an invalid base station packet might be received at a command center. For example, a personal security transmitter may have been reported as lost or stolen. In this case, if the transmitter is activated, it may have been activated for any number of reasons having nothing to do with an actual call for assistance. Thus to prevent false alarms and ensure that responders are available if a real call for assistance is received, the processing unit at the command center should be programmed to ignore any activation signals received from a lost or stolen transmitter. Alternatively, the processing unit can be programmed to flag or mark activation signals received from a lost or stolen transmitter for special processing. In this way, police can respond appropriately to reclaim lost or stolen transmitters and apprehend unauthorized users.

In an embodiment of the present invention, the header “BEACON_PN” followed by a six-digit transmitter identification number is sent by a personal security transmitter and checked by a processing unit at the command center to determine whether a valid base station packet was received.

Referring to FIG. 2B, in step 245 information contained in received base station packets is logged for future reference.

In step 250, a transmitter identification number for each received base station packet is determined for use in steps 255 and 260. Steps 255 and 260 are performed in parallel.

In step 255, the transmitter identification number determined in step 250 is used to retrieve personal identification information. In an embodiment, the transmitter identification number is used as an index to a record in a data base. The data base record contains personal identification information about the person to whom the transmitter was issued, such as the person's name, address, and medical history. The data base record also contains a photograph of the person to whom the personal security transmitter was issued and the name and address of a person to contact in the case of an emergency. In another embodiment, the data base record might contain a physical description of the person to whom the personal security transmitter was issued rather than a photograph. The benefit of using a transmitter identification number to retrieve personal identification information from a data base is that a large amount of information, which is useful in responding to a call for assistance, can be retrieve at a command center in an accurate and expeditious manner. Other advantages of retrieving personal identification information from a data base will be known to a person skilled in the relevant art(s) given this description.

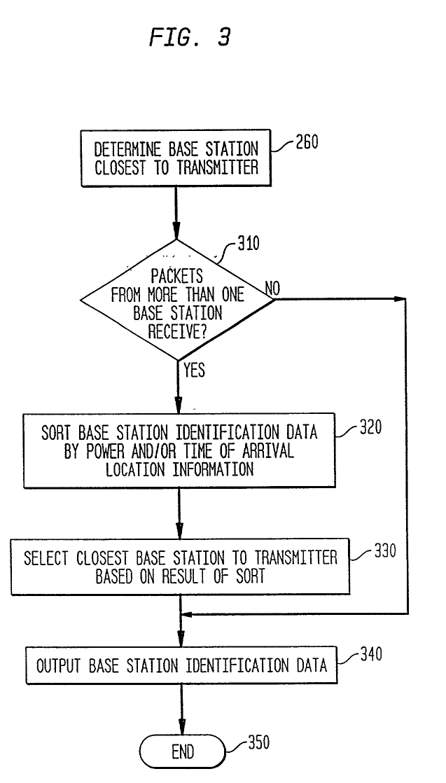

In step 260, the base station closest to an activated transmitter is determined for use in subsequent steps of method 200. The method used to determine the closest base station to a transmitter will depend on the type of location information transmitted to the command center from the base station. In one embodiment of the present invention, both a signal time of arrival time stamp and signal power data are sent to a command center from the base station. How this information may be used to determine a base station closest to a transmitter is shown in FIG. 3.

FIG. 3 shows a routine for determining a base station closest to a transmitter 260 according to an embodiment of the present invention. The routine starts at step 310.

Referring to FIG. 3, in step 310 a check is performed to determine whether more than one base station packets have been received relating to a single transmitter. It is likely that more than one base station packets will have been received at a command center because a transmission packet signal may be received by one or more base stations, which may be fixed or mobile. If only one base station packet was received for a particular transmitter identification number, during some specified period of time, control is passed to step 340. Otherwise, control is passed to step 320.

In step 320, all base station packets for a given transmitter identification number are sorted according to the location dependent information received. In step 330, the base station closest to the transmitter is selected based on the results of the sort performed in step 320.

In the case where a time of arrival time stamp is received, the base station which sent the earliest time stamp is selected as the base station closest to the transmitter. In one embodiment, each base station packet sent to a command center contains a base station identification number. In this embodiment, base station identification numbers are sorted in step 320 and listed in an order according to their associated time stamps. In sorting base station identification numbers and time stamps, however, it is important to take into account the transmission frame numbers of the base station packets. As described above, in one embodiment, transmitters send a transmission frame number in their transmission packet signals. A transmission frame number can be used to verify that the time stamps being sorted are associated with the same transmission from a transmitter. Only time stamps associated with a single transmission frame number should be used to determine a base station closest to the transmitter.

A transmission frame number may be generated in a transmitter using a counter. After each transmission, the counter is incremented. The transmission frame number would be the state of the counter at the time the transmission is sent.

In an embodiment where power data is sent to the command center by the base stations, the power data is sorted by power level. In a manner similar to that described above for time stamps, power data is sorted and listed according to the strength of the transmission packet signal received at a base station. The base station identification number associated with the highest power signal received is selected as the base station closest to the transmitter. In this embodiment, it is also important to consider only power data associated with a single transmission frame number.

A person skilled in the relevant art(s) would know how to write a computer program that could be used to implement routine 260 given this description. This program could then be run on a computer or microprocessor located at a command center. Routines other than the two described above for determining a base station closest to a transmitter are contemplated and would be known to a person skilled in the relevant art(s).

In step 340, the base station identification number selected in steps 320 and 330 as that being closest to a transmitter is output to step 265 in FIG. 2B.

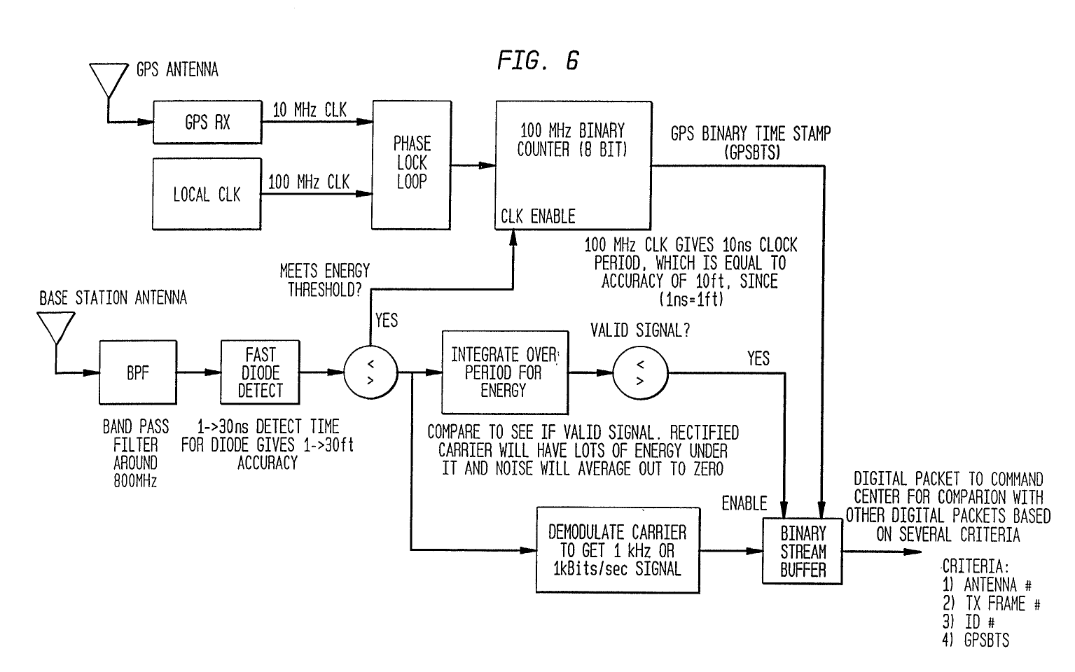

Referring to FIG. 2B again, in step 265 the personal identification data retrieved in step 255 and the base station closest to a transmitter are displayed. In an embodiment of the present invention, this information is displayed on a computer display at a command center. The types of information displayed in step 265 are shown in FIG. 6. In an embodiment of the present invention, the display at the command center shows a map having the location of all the base stations in a particular security area on it. In this embodiment, the base station closest to a transmitter on the map flashes or blinks to draw the attention of an observer.

Steps 270-280 are optional steps, in which a command center packet is sent back to one or more base stations to initiate some sort of local action at one or more base stations. For example, once the closest base station to an activated transmitter is identified, a command center packet could be sent to the base station, which would sound an alarm. Other possible actions are that the command center packet would cause emergency lights to flash or cause a recording to be played, which would alert people in the vicinity of the base station to the fact that the police have been summoned, and they are on their way. Other possible actions are also contemplated, which would be known to a person skilled in the relevant art(s) given this description. Method 200 ends at step 285.

Although not shown, it is possible to make the steps of method 200 iterative. In an embodiment of the present invention, a personal security transmitter, once activated, continues to periodically transmit transmission packet signals until it is turned-off or reset. These periodic transmissions are then used to continually update the display at a command center and show the latest location of the transmitter.

System for Providing Location and Personal Identification Information to a Public Safety Answering Point

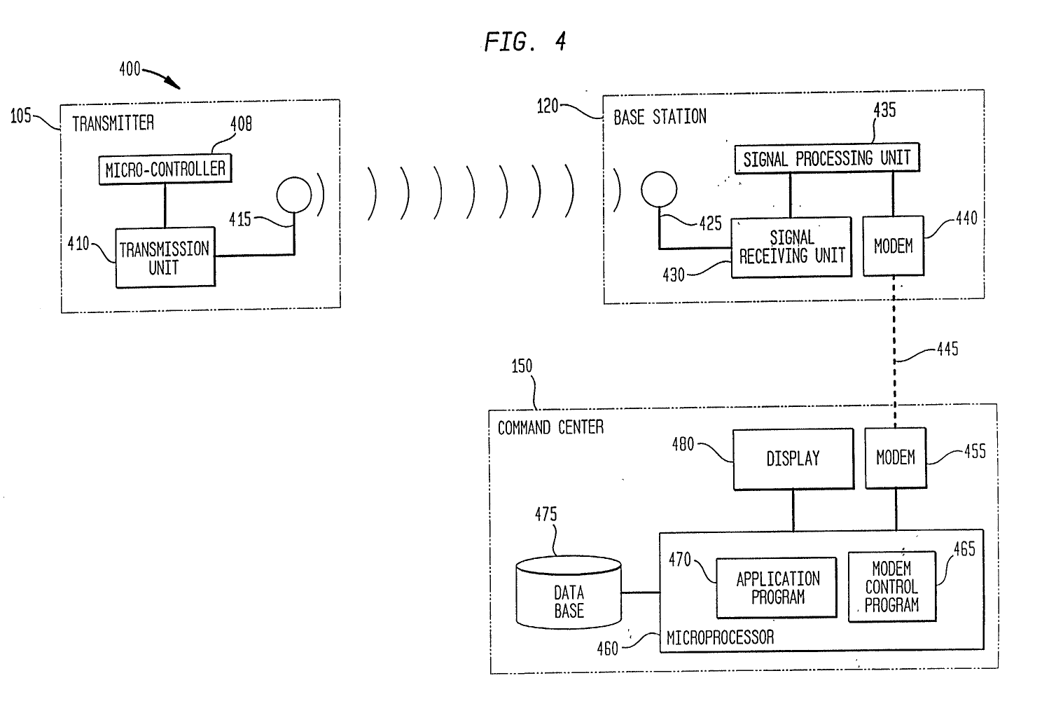

FIG. 4 is a block diagram of a system 400 that can be used to implement an embodiment of the present invention. The system comprises a transmitter 105, a base station 120, and a command center 150.

Transmitter 105 comprises amicro-controller408, a transmission unit 410 and an antenna 415. Micro-controller 408 is used to store a transmitter identification number and other data, such as a header and a version number. Micro-controller 408 can be used to generate a transmission frame number and a error check number. In one embodiment, micro-controller 408 is a MICROCHIP PIC16C74A, available form MICROCHIP TECHNOLOGY INC. Transmission unit 410 takes data from micro-controller408 and transmits it using antenna 415. In an embodiment, transmission unit 410 is an ARF2104 module available from ADEUNIS RF and XEMICS SA. An ARF2104 provides a serial communication channel with a selectable bit rate between 4,000 and 64,000 bits/second. An ARF2104 is based on the XEMICS XE1201 single chip device, working at 433.9 MHZ according to the European standard ETS 300-220/ETS 300-683. Antenna 415 can be any antenna compatible with transmission unit 410. How to combine this unit to form transmitter 105 would be known to a person skilled in the relevant art(s) given this description.

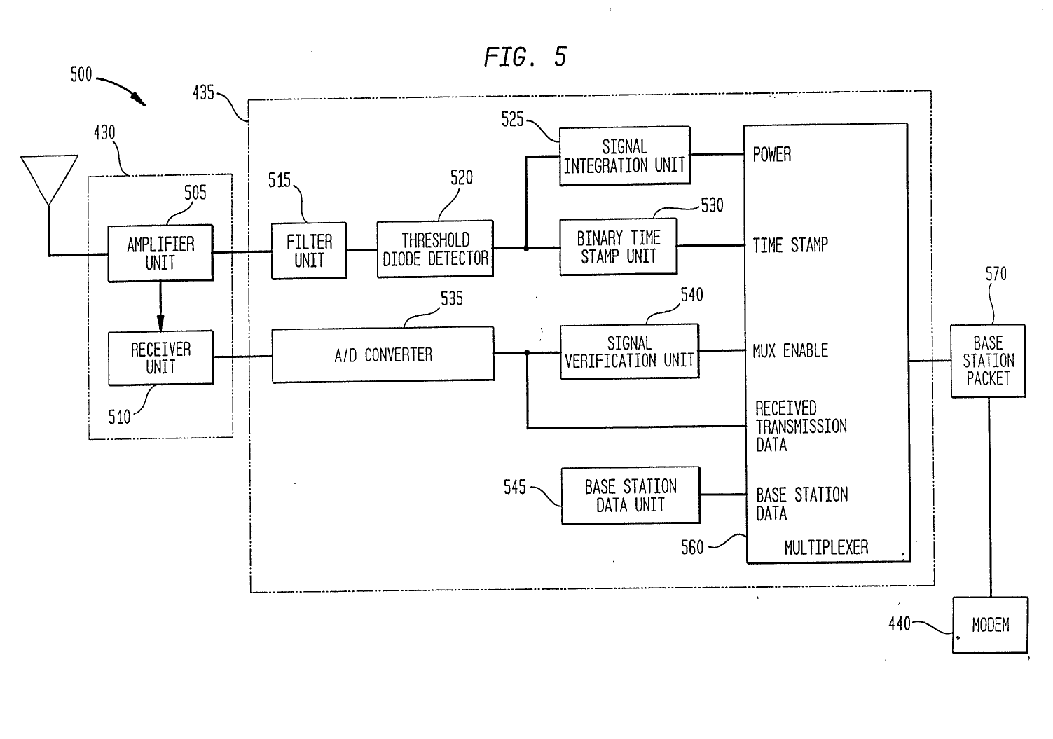

Base station 120 comprises an antenna 425, a signal receiving unit 430, a signal processing unit 435, and a modem 440. Antenna 425 is any antenna that is compatible with signal receiving unit 430. In an embodiment, signal receiving unit 430 is the same ARF2104 module that is used for transmission unit 410, described above. Signal receiving unit 430 receives a transmission packet signal and demodulates it. The demodulated information is then provided to signal processing unit 435. Signal processing unit 435 combines some or all of the information from a transmission packet signal with other information, such as a base station identification number and location data, to form a base station packet. Signal processing unit 435 is described in more detail below with regard to FIG. 5. Once a base station packet is generated, it is transmitted to a command center using modem 440 and communications link 445. In an embodiment, modem 440 is a readily available commercial modem, such as a modem used with a personal computer, and communications link 445 is a telephone line.

Referring to FIG. 5, a block diagram of a base station according to one embodiment of the present invention is shown. In this embodiment, signal receiving unit 430 is shown as comprising a separate amplifier unit 505 and a separate receiver unit 510. Amplifier unit 505 amplifies a received signal, and receiver unit 510 demodulates a received signal. How to implement these units would be known to a person skilled in the relevant art(s) given this description.

In FIG. 5, signal processing unit 435 is shown as comprising a plurality of units 515-560. As shown in the top half of FIG. 5, an modulated transmission packet signal is passed through a filter and impressed across a threshold diode detector to determine whether a transmitter signal has been detected. Filter 515 is a narrow bandwidth filter centered on the frequency of the transmission packet signal carrier. If a transmitter signal is detected, the power of the signal is determined by signal integration unit 525 and a binary time stamp is produced by binary time stamp unit 530. Means for integrating a signal to determine its power would be well known to a person skilled in the relevant art(s) given this description. A global positioning system (GPS) receiver and a local clock, whose outputs are synchronized using a phase lock loop, together with a counter may be used to generate a binary time stamp, as would be known by a person skilled in the relevant art(s) given this description. The outputs of signal integration unit 525 and binary time stamp unit 530 are provided to the inputs of a multiplexer 560.

As seen in the bottom half of FIG. 5, a demodulated copy of a received signal is provided to an analog-to-digital converter 535 from receiver unit 510. After signal information is converted from an analog form to a digital form, the information from the received signal is provided to a verification unit 540. This unit might, for example, check to see if a proper personal security header has been received. If a proper signal has been received, signal verification unit 540 provides an output signal which enables multiplexer 560. Once enabled, multiplexer 560 produces a base station packet 570, which is transmitter to a command center using modem 440. A person skilled in the relevant art(s) will notice that certain units not relevant to the present invention, such as a local clock to switch multiplexer 560, have been omitted from FIG. 5 for the sake of clarity.

As can be seen in FIG. 5, the base station packet generated by multiplexer 560 includes information received by receiver unit 510, power information about the received signal from integration unit 525, and a binary time stamp from binary time stamp unit 530. The base station packet also contains other base station data provided by base station data unit 545, such as a base station identification number.

In an embodiment of the present invention, many of the units that make up signal processing unit 435 are replaced by a single microprocessor. A person skilled in the relevant art(s) would know how to implement units of signal processing unit 435 using a microprocessor given this description.

FIG. 6 shows another embodiment of a base station according to the present invention. Based on the discussion herein and the explanatory notes in FIG. 6, a person skilled in the relevant art(s) would know how to implement this embodiment.

In an embodiment of the present invention, the base station locations are fixed. For example, a base station could be mounted on top of a commercial telephone call box or an emergency telephone call box. In this embodiment, the base station could use the existing telephone lines of the call box as a communications link to a command center. The base station can connect to the existing telephone lines using a modem.

In another embodiment of the present invention, base stations are mobile.

For example, base stations are mounted in an vehicle, such as a campus police vehicle. A mobile base station has a GPS receiver, which is used to generate the location of the mobile base station at the time a transmission packet signal is received. A wireless communications link can be used to connect a mobile base station to a remote command center. Additionally, a mobile base station can be combined with a mobile command center, which is capable providing both location dependent information and personal identification information to the user of the mobile base station and command center.

In still another embodiment, fixed base stations and mobile base stations are integrated into a signal system. This embodiment has base station located in a fixed location, such as on top of telephone call boxes, poles, or buildings, and mobile base stations mounted in vehicles.

Referring to FIG. 4 again, a command center 150 according to one embodiment of the present invention is shown. Command center 150 comprises a modem 455, a microprocessor 460, a data base 475, and a display 480. Microprocessor 460 is used to run a modem control program 465 and an application program 470. All of the units of command center 150 can be implemented on a single personal computer.

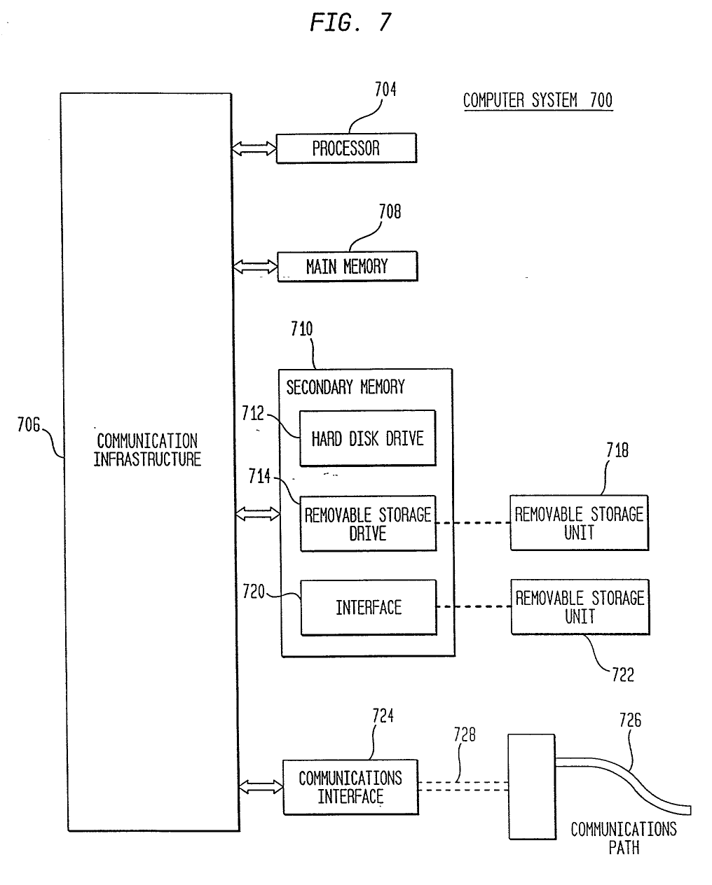

Referring to FIG. 7, an example of a computer system 700 is shown, which can be used to implement elements 455-480 of command center 150. Computer system 700 can execute software to carry out any of the functionality described herein with respect to command center 150.

Computer system 700 represents any single or multi-processor computer. Single-threaded and multi-threaded computers can be used. Unified or distributed memory systems can be used.

Computer system 700 includes one or more processors, such as processor 704. One or more processors 704 can execute software implementing all or part of command center 150 as described herein. Each processor 704 is connected to a communication infrastructure 702 (e.g., a communications bus, cross-bar, or network). Various software embodiments are described in terms of this exemplary computer system. After reading this description, it will become apparent to a person skilled in the relevant art how to implement the invention using other computer systems and/or computer architectures.

Computer system 700 also includes a main memory 708, preferably random access memory (RAM), and can also include secondary memory 710. Secondary memory 710 can include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well known manner. Removable storage unit 718 represents a floppy disk, magnetic tape, optical disk, etc., which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means can include, for example, a removable storage unit 722 and an interface 720. Examples can include a program cartridge and cartridge interface (such as that found in video game devices), a removable memory chip (such as an EPROM, or PROM) and associated socket; and other removable storage units 722 and interfaces 720 which allow software and data to be transferred from the removable storage unit 722 to computer system 700.

Computer system 700 can also include a communications interface 724. Communications interface 724 allows software and data to be transferred between computer system 700 and external devices via communications path 726.

Examples of communications interface 724 can include a modem, a network interface (such as Ethernet card), a communications port, etc. Software and data transferred via communications interface 724 are in the form of signals which can be electronic, electromagnetic, optical or other signals capable of being received by communications interface 724, via communications path 726. Note that communications interface 724 provides a means by which computer system 700 can interface to a network such as the Internet.

The present invention can be implemented using software running (that is, executing) in an environment similar to that described above with respect to FIG. 7. In this document, the term “computer program product” is used to generally refer to removable storage unit 718, a hard disk installed in hard disk drive 712, or a carrier wave or other signal carrying software over a communication path 726 (wireless link or cable) to communication interface 724. A computer useable medium can include magnetic media, optical media, or other recordable media, or media that transmits a carrier wave. These computer program products are means for providing software to computer system 700.

Computer programs (also called computer control logic) are stored in main memory 708 and/or secondary memory 710. Computer programs can also be received via communications interface 724. Such computer programs, when executed, enable the computer system 700 to perform the features of the present invention as discussed herein. In particular, the computer programs, when executed, enable the processor 704 to perform the features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. Alternatively, the computer program product may be downloaded to computer system 700 over communications path 726. The control logic (software), when executed by the one or more processors 704, causes the processor(s) 704 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

In an embodiment of the present invention, application program 470 is a software program written to implement steps 245-270 of method 200. A person skilled in the relevant art(s) would know how to write a software program that implements these steps of method 200 given the description herein.

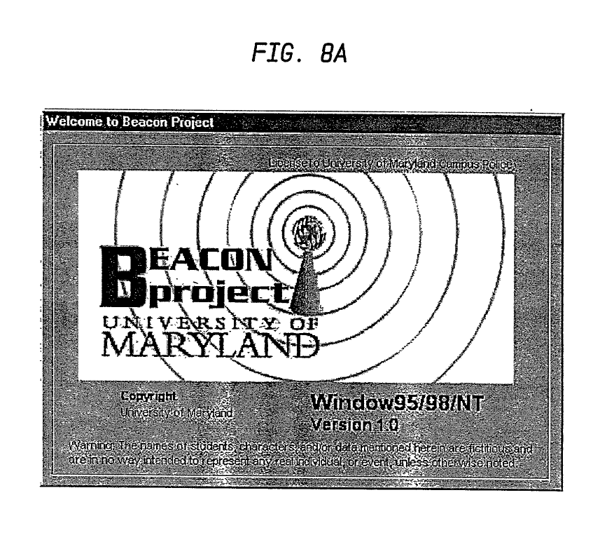

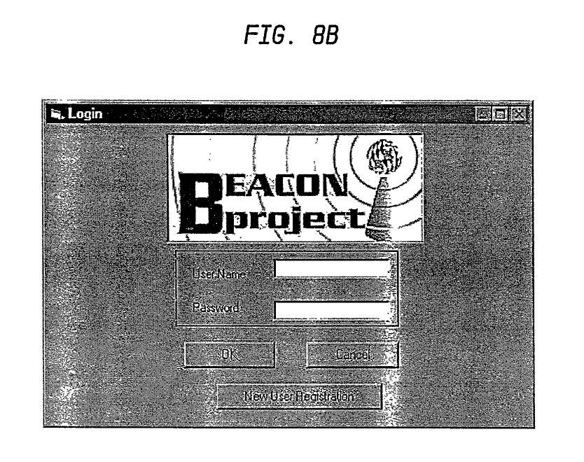

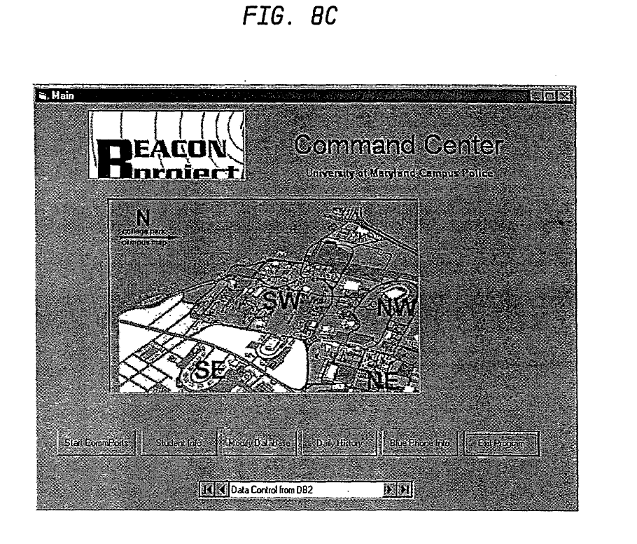

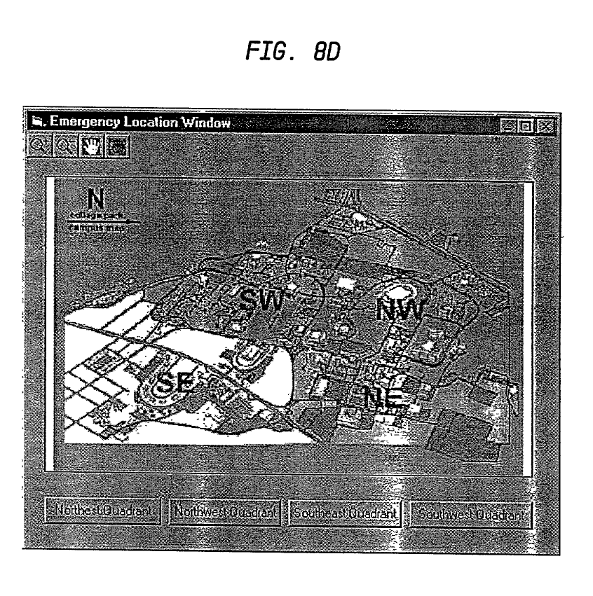

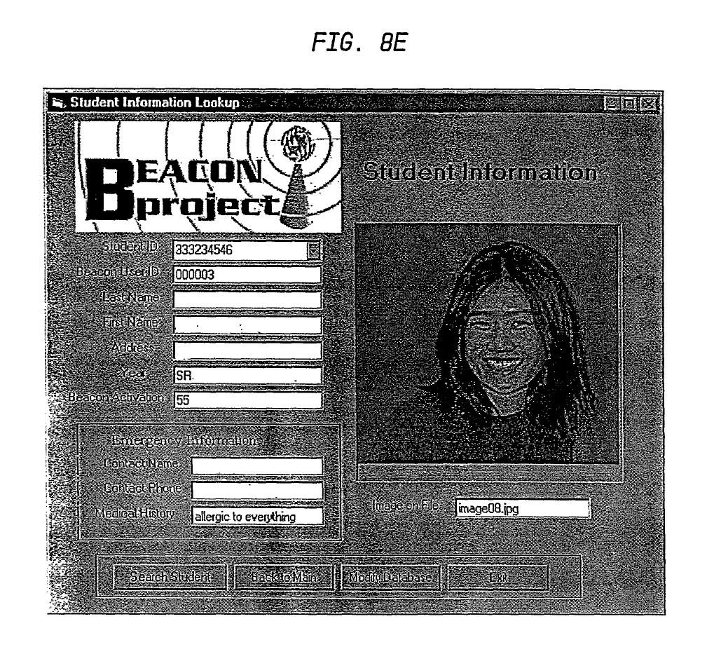

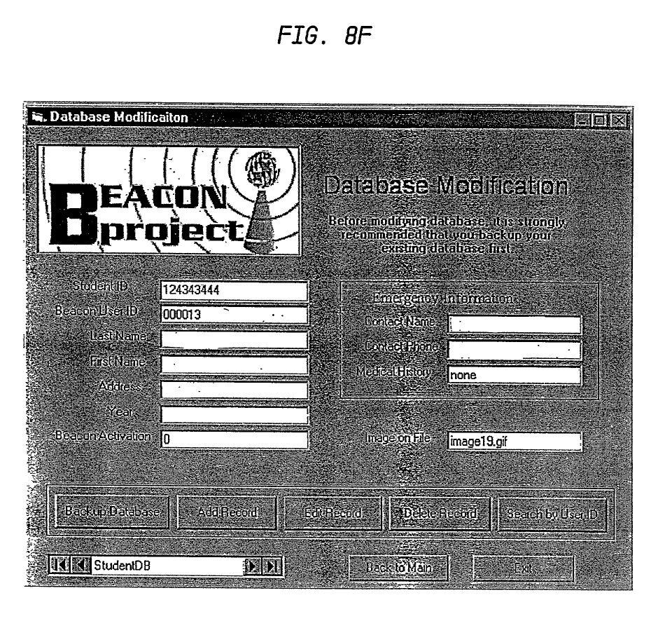

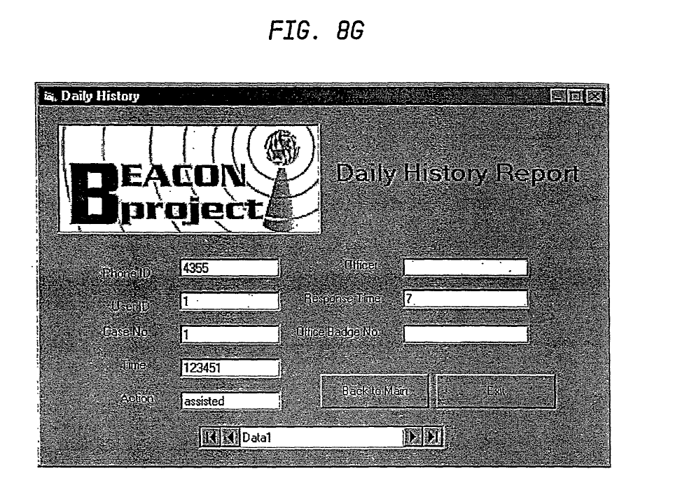

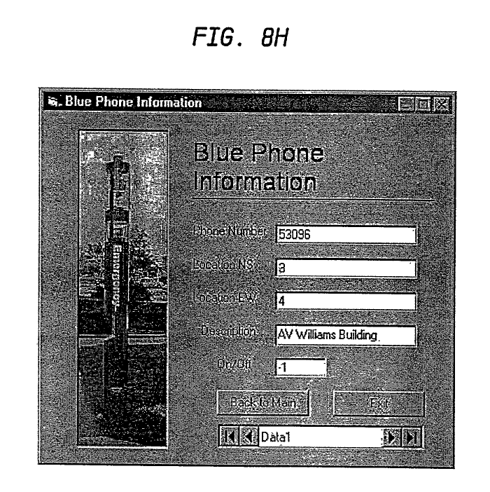

FIGS. 8A-8H are examples of some graphical user interfaces that can be displayed to a user of the present invention, located at a command center, according to one embodiment of the present invention. FIG. 8A is a display screen welcome menu. FIG. 8B is a user login menu. FIG. 8C is the main menu of application program 470. FIG. 8D is a map of the security area covered by base stations according to the present invention. FIG. 8E and FIG. 8F are example personal identification information screens. FIG. 8G is an example activity report screen. Finally, FIG. 8H is an example base station status screen.

Beacon Emergency Locator System Example Embodiment

The following example embodiment is referred to as the Beacon Emergency Locator System for a university. This example is illustrative and-not intended to limit the present invention. In this embodiment, the personal security transmitter has the following features:

It is a hand held transmitter;

It is small in size, i.e., less than 2 lbs with key chain dimensions similar to remote car opener;

It has memory to store unique transmitter ID numbers, i.e, enough for at least 65,000 unique values.

It has self test feature, i.e., pressing a button gives some indication to the user about the state of the battery and whether the transmitter is working;

It is stylish so that users won't mind carrying it around;

It is not easy to accidentally activate;

It has a range of about one mile;

It can transmission through buildings, walls and other obstacles;

The battery provides enough energy to transmit for at least five minutes;

A user can change the battery, but the battery is not be easily accessible; and

the device is durable.

In this embodiment, the overall system has the features:

It alerts the campus police that there is a problem on campus in a particular location;

It operations continuously, with out interruptions for maintenance;

It work in all weather conditions (humidity, precipitation, heat etc);

It has receiver redundancy so that if one receiver goes down, others can compensate; and

It locates individual transmitters within a specified radius.

Radio Frequency Transmission

A prototype transmitter and receiver was developed using a PIC16C74A micro-controller connected to an ARF2104 receiver connected to an in-house fabricated antenna. The receiver consisted of another in-house constructed antenna connecting to the Octagon systems board.

Radio frequency wireless transmission was accomplished using a pair ARF2104 transceivers. These transceivers operate at a frequency of 433.9 MHZ and run on power inputs between 0-3 Volts. A whip antenna was used to ensure optimal transmission. Operation at four transmission rates is possible: 4 kbps, 16 kbps, 32 kbps and 64 kbps. To ensure reliable transmission, however, the data baud rate should be lower than the desired transmission rate.

Testing of the transmitter/receiver pair was accomplished by sending data from one transceiver to another. The testing involved sending four-bit hexadecimal ASCII values. These values were represented and sent using voltages between −10 volts and +10 volts. A voltage range translation device (MAX233CPP) was used to shift the voltage range from [−10V, +10V] to [0V, +5V]. A further down-conversion to reduce the upper limit from +5V to +3V was performed using a voltage divider, to make the voltage range compatible with the requirements of the transceiver. A 10 kW potentiometer was placed in series with the output of the voltage translation device to appropriately reduce the output voltages. The data rate should be smaller than the transmission rate to ensure that the data is not generated faster than it can be transmitted.

The PIC is used to create an ID to send over the RF link. The actual data to be sent over the RF-link is preprogrammed into the PIC, and the RX side of the transmission link sets the specifications for the data packets. The information to be sent over the RF link is initialized and then stored into memory locations. Those memory locations are then accessed by Interrupt Service Routines (ISR's) while the PIC is running. These ISR's are where the actual signals are sent to the RF transmitter. ISR's are used to ensure that the hardware is ready to accept new data before outputting data. This way you ensure that you are not overwriting data put out to the ports. When data is sent out to the RF transmitter it is done through a serial transmission, but in the code, it is set up so that you can input two bytes, and then the code will prepare those two bytes to be sent out. The following is an outline of the code:

1. Power On

2. Initialization of variables

3. Initialization of Ports

4. Initialization of internal timer

5. Setup of Service Interrupts

6. Begin infinite Main Loop

7. Everything done after this point is handle by the Interrupt Service Routines.

Base Station

A base station prototype was built using a single board computer (SBC). It is a 386 SX running an embedded version of DOS (Disk Operating System). The SBC essentially had one input and one output. The input was a FSK (Frequency Shift Keying) transceiver chip which sat on an evaluation board. The board was directly linked to the SBC through a serial port. The output was an off the shelf external 56K modem. The modem also connected through a serial port. Below is the packet structure of the data sent from the transmitter to the base station.

| | | | | |
|---|---|---|---|---|
| PN header | ID # | TX Frame # | Version # | CRC Error check # |

The Beacon PN is a unique word to identify the received signal as a “Beacon signal,” or one to be considered by the Beacon signal processor. The ID is an identification number specific to the transmitter that sent the signal. This ID will be used to tell who (which transmitter) activated the Beacon system. The TX Frame number is a sequence number, used to know which number packet is received from the transmitter. This field will be sent by the transmitter to label each packet it sends so that the Command Center can compare the same packet coming in from different base stations. This is used to avoid cycle'slip. The Version number specifies the data structure and signal processing algorithm. This field can be used to update the system or let the signal processor differentiate its services. The CRC is the cyclic redundancy check algorithm that is used to determine if there are errors in the transmission.

The Beacon PN (short for pseudo-random number) can be any specific value. The value chosen in the prototype was “BEACON_PN.” The length of the unique word can be determined by considering the probability of two types of errors, probability of detecting the expected PN when no PN was sent (P[D|S′]) and the probability of not detecting the signal when a Beacon signal was sent (P[D′|S]). These probabilities are considered without the use of error detection algorithms.

The probability of incorrectly detecting a Beacon signal is the same as the probability of generating one unique word in a set of equally likely words.

$$P [ D \vert {S}^{′} ] = \frac{1}{{2}^{N}} ,$$

, for a unique word that's N bits long.

For a nine character Beacon PN, P[D|S]=2.12×10⁻²². A three character Beacon PN would give a P[D|S]=5.96×10⁻⁸.

The probability of not detecting a signal, when one was actually sent is estimated below. Since a packet will be sent multiple times from a transmitter to a receiver, this probability will decrease exponentially over time. Nonetheless, considering just thermal (AWGN) noise and eliminated inter-symbol interference, the probability of not detecting a signal is the probability of one bit error for an FSK transceiver, which is

$${P}_{e} = \frac{1}{2} erfc ( \sqrt{\frac{{E}_{b}}{2 {N}_{o}}} )$$

where erfc( ) is the complementary error function, E_{b} is the energy of a signal bit, and Nₒ is Bolzman's constant times the temperature.

The probability of not detecting the Beacon PN in a single packet can then be realized by the binomial distribution:

P[D′|S]=1−P[0 errors in N bits]=1−(1−Pₑ)ˆ N

For the current ARF2104 transceiver, which transmits at 10 mW at 433.9 MHz, E_{b}=2.3*10ˆ (−11)J.

P[D′|S]=1−(1−0.5erfc(53.6×10³))⁷²≈0

using a common value of Nₒ=4′10⁻²¹.

Cyclic Redundancy Check

Cyclic Redundancy Check (CRC) is a common algorithm used in networks to test for errors in the data stream. Since the transceiver packet will be automatically sent multiple times, it is only necessary to detect which packets are corrupted and discarded them, rather than doing any forward error protection. To do this, CRC-16 can be used.

There are several error detection properties associated with CRC-16. These properties are:

1. Any odd number of errors is detected

2. All double errors are detected as long as the block length is no greater than 2¹⁵−1.

3. All bursts of length 16 or less are detected

4. The minimum Hamming distance between codewords is 4.

5. The probability of an undetected error is 2⁻¹⁶.

Base Station Packet

Below is the packet structure of the data sent from the base station to the command center.

| Base | | | Time | TX | |
|---|---|---|---|---|---|
| station # | ID # | Power | Stamp | Frame# | Version # |
| Five | Six | Ten | Ten | Two | Six |
| Character | Characters | Characters | Characters | Characters | Characters |

The outgoing packet will contain the six data fields of base station number, identification number, power, time stamp, frame number, and version number. The base station number data field will identify the base station that sent the data. The ID, frame number and version number fields are all passed from the transmitter. The power and time stamp fields can be used for location finding.

OCTAGON 6040 Board and its CAMBASIC Program

In the prototype embodiment, an OCTAGON 6040 INDUSTRIAL PC does the signal processing at the receiver. This board utilizes a 386SX microprocessor. It has two serial communications ports (COM1 and COM2), a parallel port, three digital I/O ports, and an analog port. The processor takes data from the receiver through a serial port, parses the data, checks for a Beacon PN identifier, activates the strobe light, and sends relevant data (the outgoing packets) to the Command Center via a modem link.

In the prototype embodiment, these tasks were programmed using CAMBASIC, which is a language tailored specifically for OCTAGON boards. The program was written in CAMBASIC because of CAMBASIC's ease of use, especially with interfacing with the COM ports and I/O ports.

Data from the receiver comes into the embedded PC through COM port 1. The data is expected to be in the following form:

*Bˆ Eˆ Aˆ Cˆ Oˆ Nˆ _ˆ Pˆ Nˆ 1ˆ 1ˆ 1ˆ 1ˆ 1ˆ 1ˆ 2ˆ 2ˆ 3ˆ 3ˆ 3ˆ 3ˆ 3ˆ 3ˆ 3ˆ 4ˆ 4#

where ˆ denotes a garbage character and * and # delineate the start and end of a packet respectively. The first nine characters (BEACON_PN) are the Beacon PN. The next six characters are the identification number. The next two numbers are the frame number. The six after that is the version number of the transmitter. The final two are for a CRC number. The garbage data between each character is used for synchronization so that there are less bit errors made by the receiver. The program takes care of these garbage characters by only looking at every other character.

When data is received in communications port 1, the on_com subroutine is called. This subroutine takes the data from the COM port, and calls the parse subroutine, which parses the data into the five fields mentioned above and then returns from the subroutine. If the Beacon PN field pulled from the COM port matches the ‘BEACON_PN’ string, then the good_data function is called; otherwise, the on_corn subroutine returns. The good_data function activates the strobe light on the base station, if it is not already active, dials the modem, if it is not already dialed, and sends the data (location, user ID, power, time stamp, frame No, vers No) to the Command Center. Then the program waits for more data to come into the COM port. If no good data comes into the COM port within ten seconds, the modem hangs up and the strobe is deactivated.

Only a relay and some wires are needed, along with the OCTAGON 6040, to activate the strobe light. Digital I/O lines are used to control a relay, which in turn controls whether the strobe light is on or off. A relay is a mechanical device that shorts two wires together when the proper voltage and current is applied to its coil. The relay chosen for the embodiment of the prototype is a MAGNECRAFT W172DIP-251.

In the CAMBASIC code, the EZIO lines are be configured by:

Config EZIO &140,&0, &0, &ff, &0, &ff, &0

The command Out &140,8 turns the relayon, and the command Out &140,0 turns the relay off.

Base Station to Command Center Link

The communications link from the base station to the command center is a normal modem in the prototype. At the base station end an external modem was connected to the OCTAGON SBC through a serial port. On the SBC end the modem is controlled using the following procedure.

1. Initialize the COM port;

2. Initialize the modem;

3. Dial the number to call.

4. Send data to directly to the COM port.

The command center prototype consists of a single computer running MICROSOFT WINDOWS 98 with a PC Card modem. The software was written entirely in VISUAL BASIC (VB) 6.0.

The purpose of the modem control portion of the command center is two fold. First, it is to establish a connection with the modem on the SBC when there is an incoming call. Second, it is to parse through the incoming data and place it all in the appropriate data structures.

The serial port communications control is a piece of software that was imported directly into VB. It is used to control a serial port.

Command Center

In order to minimize software development time, the command center application program was written using VISUAL BASIC. VISUAL BASIC (VB) is a language that enables developers to produce software in a rapid pace with visual aids. The following flow chart summarizes the design of the software.

| Form/Module | |
|---|---|
| Name | Functionality Overview |
| FrmSplash1 | Splash screen the users will see first after starting the |
| | program. |
| frmLogin | Login screen. User name and password must be |
| | provided. |
| frmMain | Main switchboard. Buttons linked to other forms. |
| FrmTerminal | Modem form, users activate modem comm port from |
| | this form. |
| FrmViewData | Modem form., users view parsed data from a text |
| | string off the modem comm port. |
| FrmProperties | Modem form., contained within frmTerminal, invisible |
| | to user. |
| FrmCancelSend | Modem form, contained in frmTerminal, invisible to |
| | user. |
| Module 1 | Vbterm.glo, modem code. |
| FrmUser | User information lookup. |
| FrmModDb | Modify user information. |
| FrmDailyHis | View records of today's incoming calls. |
| FrmBaseStation | View base stations information. |

The GUI component of the software consists of many forms users see. Below is a detailed description of each of these forms.

frmSplash: The splash screen is the first screen a user will see when starting the program.

frmLogin: The login screen asks the user to enter a user name and a password. If the user doesn't have these information, he/she can click on “New User Registration” to obtain one. This form is linked to a database table called UserLog. Available user names and passwords are listed inside this table. And the login procedure queries this table and checks for the user name and password match.

frmMain: This form allows one to start the terminal, the user information search form, modify user information database form, daily history form, and the base station form.

frmTerminal: The user can turn on the Comm port from this window. Typing in ats0=1 sets the modem to listen to the Comm port automatically. This command is the auto receive command. This window also display any text strings coming in from the modem.

frmMapObj: This form is created using Map Objects. Map Objects is an add-on to VISUAL BASIC that allows the use of geo-records. In this form, we have incorporated a few features. On the top button bar, we have included the Zoom In, Zoom Out, Pan, and Full Screen options. This is achieved with Map Objects by using map coordinates. A user can draw a rectangle so he/she can Zoom In the map and also Zoom Out to the previous stage. A user can also use the Pan feature to further locate the base station that has gone off or look at the surrounding area of a distressing base station activation. The Full Screen basically brings the user back to the original screen. On the bottom portion of the map, we have 4 buttons which divides the campus into 4 quadrants. In each of these quadrants, there is a fully functional similar map screen with the above mentioned functions.

frmUser: The user form provides an individual at the command center information about the user that has activated the emergency beacon. This form will appear on the monitor whenever a beacon has been activated and will provide only information with regards to the user involved. Other user information can be retrieved from the database by changing the entry in the User ID field. This is a pull-down combo box that will display the additional User ID's in the system. All the other fields in the form are write protected and cannot be changed while viewing. The other fields are all linked in the database to the User ID. The following information is provided with each record: a unique Beacon User ID, first and last name, a local address, the name of the image file being used in the form, and emergency information such as a contact person and phone number, and any emergency medical information. The User Search button allows the user to search for a user by User ID. The Back To Main button brings up the main form and hides the User ID form. The Modify Database button brings up the form frmModDb to allow the user to add or change information in the database. The Exit button closes the User Information Form. Instead of using ADO objects, we used SQL statement associated with the combo box change. Beacon ID will be locked, and automatically assigned by Access database's autonumber functionality. Every box is locked without changing.

frmModDb: This form provides the user access to the database in order to add, change or remove entries from the-database. The same information that was provided in the User Information form has an editable box in this form, with the addition of an box for entering the amount of times a beacon has been activated for each user. All the boxes in this form are linked to the User ID field in the database. The Backup Database button allows the user to save the database before any changes are made. This provides a double assurance that the database will not be lost or if unwanted changes are made the old database can be retrieved. Records then can be modified in the database using the Add Record, Edit Record, or Delete Record buttons. The Search By User ID button allows for quick addressing of information based on data entered into the User ID box. The scroll box provides a link to the section of the database that will be modified. The Return To Main and Exit buttons have the same functionality as in the User Information form.

frmBaseStation: The base station form provides information with regards to each base station that is being utilized in the Beacon system. All base station information is linked to a four-digit number that is the last four digits of a base station number. The form provides North-South and East-West grid locations that are related to the map used. The form also gives a brief description of where the base station is located and whether the base station is activated (off=−1,on=+1). The scroll bar provides a link to the database being utilized. The Exit and Return To Main buttons have the same functionality as discussed earlier.

frmDailyHis: The Daily History Report form is an event driven form that appears each time an emergency beacon is activated. The is the mechanism by which the command center personnel enter information related to an ongoing event. For each activation of the emergency beacon, a entry in the database is created that contains the following fields: the User ID of the user activating the beacon, an assigned case number for each activation, the time the event took place, the action taken by personnel responding to the beacon, and name and badge number that responded. In addition, a Response Time field is provided for later statistical evaluation. The Exit and Back To Main buttons have the same functionality as discussed previously.

Database Design

In the embodiment of the prototype, the relational database was designed using MICROSOFT ACCESS so that the VISUAL BASIC GUI could easily update information, as it became available. The database would store incoming information and could be queried by the VISUAL BASIC program in order to pull up relevant data when an emergency beacon was activated. The database was designed to provide the police user information and be a source of statistical event information. Incoming packets were parsed and used to populate an Incoming Calls section of the database. The information was double-sorted to User ID initially, then within each unique User ID, a secondary sort arranged the entries in order of decreasing power levels. The highest power level for each User ID was copied into a second portion of the database called History Log. This portion of the database sets off the VISUAL BASIC program to display an event window informing the user at the command center that a beacon has been activated. This portion of the database accesses other more static information such as User Information and Base Station Information portions of the relational database. The History Log provides fields for statistical information such as actions taken, response time, responding officers, and case numbers; which are entered by the user of the command center at the time of the event. The database also keeps track of the amount of times a user activates the emergency beacon. The database was designed to allow the most functionality while minimizing redundancy and storage space.

Second Embodiment of a Beacon Emergency Locator System:

A second example embodiment of the BEACON Emergency Locator System is similar to the embodiment shown in FIG. 6. The technical aspects of this embodiment of the BEACON project include:

1. Location Techniques

2. Identification Techniques

3. Modulation issues

4. Device Design-size, power constraints

5. Receiver Location Matrix

6. Signal processing-analog to digital

7. Receiver network management

8. Server side processing issues

9. Signal/Location algorithm development

10. Reliability issues

Location Techniques

The core function of the BEACON system is to locate an individual quickly and reliably in the event on an emergency. The primary method used for radio location is an existing technique called wireless triangulation. This technique uses information sent by the mobile BEACON device to a receiving tower to calculate the location of the emergency “beacon”. The distance that the emergency signal travels is equal to the time it takes for the signal to travel from the mobile locator to a receiving tower (Time of Arrival) multiplied by the speed of light.

Distance to the locator=(Time of Arrival)×(Speed of light)

By using at least three receiving towers or Base Stations (BS) to measure the Time of Arrival (TOA), we can geometrically calculate the mobile emergency locator's position. It is also possible to derive the location of the mobile station (MS) using the Angle of Arrival (AOA) of the emergency signal or the Time Difference of Arrival (TDOA).

Identification Techniques

The BEACON system is able to identify both the location of an emergency transmission and who is transmitting the beacon. The transmission includes a unique tag used for locating the mobile transmitter and the individual's ID. A central processing center, or command center, takes information received by base stations and correlates it to pinpoint the position of the distress call. In addition, the command center looks up the ID number and displays the identity of the individual initiating the distress call and any relevant information (medical information as supplied by the individual, etc.). By identifying the person that initiates the emergency call, cases of intention false alarms are reduced.

Modulation Issues

The amount of data to be transmitted to the base stations is very small in comparison to current information rates utilized throughout the industry today. Current modem technology is capable of 56,000 bps. The burst of information sent by the emergency transmitter may contain two segments:

| | |
|---|---|
| Unique BEACON Code Cell (UBCC) | Unique ID Code Cell (UICC) |

This cell based scheme can be altered to accommodate more information if a design requires additional flexibility. To identify 32,000 users uniquely, a 15 bit ID cell is required. A 16 bit ID cell gives 65,000 unique codes and a 17 bit cell gives 131,000 unique codes.

If we add the size of the Unique BEACON Code Cell (such as a pseudo-random 10 bit stream) to the size of the Unique ID Code Cell, the size of the information burst is still under 30 bits. Adding additional error correction coding to improve the reliability of the data still leaves the total size of the information burst under 50 bits.

A transfer of 50 bits is readily accomplished using a transfer rate of 56,000 bits-per-second. The modulation techniques employed to transmit the information burst benefit from these low transfer rates. Forward Error Protection (FEQ) techniques can be used to improve the performance and reduce the size of the transmitter battery and the length of the transmitter antenna.

Device Design—Size and Power Constraints

The BEACON emergency locator design uses a transmitter approximately the size of a small key chain. The size of the locator is important for five reasons:

Smaller devices are easier to carry around and access quickly;

A key chain device would be most accessible in an emergency;

Smaller devices are less expensive to manufacture in bulk;

Low manufacturing costs mean low system costs and maintenance; and

Smaller devices with simple designs are more reliable.

The design of the transmitter device involves both power and size restraints. Battery technology is available for use in light weight applications. Since the BEACON locator only requires power when activated in an emergency, Lithium based batteries, which have an operational shelf life of at least 10 years, can be used. Button sized batteries are sold by several vendors.

Receiver Location Matrix

The chart below indicates various antenna placement options:

| | Required Transmitter | Possible Antenna |
|---|---|---|
| Antenna Spacing | Power | Placement |
| Dense | Low | On light poles |
| Sparse | High | On top of buildings |

Signal Processing-Analog to Digital

The BEACON system involves both analog and digital processing power. A digital signal processor (DSP) can be used to operate and correlate the digital data once it has been converted from analog form. The transmitter modulates the information burst over a radio carrier frequency using a modulation method suitable for digital transmission, such as pulse code modulation (PCM). Other techniques for transmitting the information bursts can also be used. Spread Spectrum is a special modulation technique that spreads the transmitted signal over a frequency range much wider than the minimum bandwidth required to send the signal. Widening the signal bandwidth in this fashion increases the probability that received information will closely match the transmitted information.

Receiver Network Management

The receiver matrix requires some form of coordination and management to insure that the system is operating correctly and to insure the command center is receiving accurate information to use when determining the location of the distress call. Using the existing base station communications network simplifies this management.

Server Side Processing Issues

The BEACON system can use processing capabilities located at the command center to:

Correlate incoming receiver signals to determine the distress call location;

Maintain and query a database of person ID information;

Provide a sector by sector overview of the campus;

Provide information relevant to emergency personnel about distress call; and

Periodically run test routines to verify the operation of the system.

The BEACON system provides these capabilities using existing computer systems or low cost personal computers, so that the overall cost and maintenance of the system is minimized.

Signal/Location Algorithm Development

The BEACON system uses several software algorithms:

A DSP based signal correlation routine to determine properties of the distress call as heard from the various receivers (phase shift, amplitude);

A location algorithm that takes the raw location data and produces a position on the electronic map at the command center;

A database routine that takes the decoded ID code and brings up identification information about the emergency caller;

A software program that records all information received at the command center for use at a later time;

A software program that could be used to communicate the distress call information to emergency personnel in the field (via phone, pager, messaging systems, CB radio, etc.); and

A menu driven “front-end” program used to monitor the system

Additional Information Related to this Example Embodiment of the BEACON Emergency Locator System

Shannon's law for digital communications tells us about channel capacity:

C=Capacity in bps (bits/sec)

B=Bandwidth in Hz

SNR=Signal to Noise Ratio=S/N

C=B log 2(1+S/N)? [symbol] Shannon's Law on channel capacity for digital communications

If solved for the SNR:

C/B=log 2(1+S/N)? [symbol] 1+S/N=2ˆ (C/B)

S/N=2ˆ (C/B)−1

It is desirable that C=1 kbps, or 10 packets (100 bits each) transmitted in one sec, and a Bandwidth of B=12.5 kHz for Binary Phase Shift Keying.

C/B=1/12.5=0.08

1000=12500 log 2(1+S/N)

S/N=2ˆ 0.08−1

The resulting minimal SNR is:

Minimal S/N=0.057˜1/17

This is the minimal signal to noise ratio required to achieve 1000 bps over a 12.5 kHz band. Even with the noise inherent to wireless transmissions, we can easily meet or exceed this minimal S/N ratio. This means the channel capacity is being under utilized.

This shows that the BEACON system can reliably transmit a data rate of C=1 kbps in a limited bandwidth of B=12.5 kbps, giving a SNR=0.057=1/17=Ps/Pn.

For larger channel capacities or data rates the SNR required to ensure reliable communication increases:

Example:

| | | | | | |
|---|---|---|---|---|---|
| 1) | C = | 2 | kbps | SNR = | 2\hat{ }(2/12.5) − 1 |
| | B = | 12.5 | kHz | Minimal SNR = | .12 |
| 2) | C = | 3 | kbps | SNR = | 2\hat{ }(3/12.5) − 1 |
| | B = | 12.5 | kHz | Minimal SNR = | .18 |
| 3) | C = | 4 | kbps | SNR = | 2\hat{ }(4/12.5) − 1 |
| | B = | 12.5 | kHz | Minimal SNR = | .25 |

It can be seen that the key to the BEACON system is that it have a low data rate in a small bandwidth. The unmodulated CW should be passed through a band pass filter (BPF) to eliminate as much noise as possible. A diode detector to detect the presence of the CW can be used.

Properties of a diode detector:

1) Original constant amplitude CW (800 Mhz):

2) Rectifies CW using fast switching RF diodes

3) Integrates the signal over time (30 ns)

4) Detects threshold to confirm signal presence

5) Given a threshold condition is met, the detector indicates it has acquired the CW beacon pulse preamble

It is important that the diode turn on quickly.

After the presence of the carrier wave (CW) is detected, the current value of a 100 MHZ local clock, which is synchronized with every other base station 100 MHZ local clock using the 10 MHZ GPS signal as a reference, is recorded. The resulting binary number produced by the 8 bit counter is a “binary time stampp” (BTS). This information is appended to the demodulated binary phase shift keying (BPSK) wave that follows the CW, once it is verified that the demodulated BPSK bits contain a BEACON PN code.

The system uses the CW, which happens to be the 800 MHZ unmodulated carrier, to synchronize the receivers, allowing them to do BPSK demodulation.

Eventually the CW portion of the burst will end and the beacon will begin modulating the signal using BPSK.

Message Signal:

| | | | |
|---|---|---|---|
| Beacon PN | TX Frame | User Id | Error Correcting |
| Code | Number | Number | Codes |

Given a data rate of C=1 kbps, it is possible to transmit a 100 bit sequence in 0.1 sec. Since one has already time stamped the CW preamble, one can accurately demodulate the slower message signal in a bandwidth B=12.5 kHz as long as the signal to noise ratio (SNR) exceeds SNR=0.057=1/17=Ps/Pn. This shows that one can have a very noisy channel and still reliably transmit the digital ID packets. Further channel coding can improve the SNR values if need be (such as block coding, convolution, forward error correction, 3 of the same bit repeated).

Now that one has detected the CW preamble and binary time stamped the signal, and synchronized up the receivers with the CW (which happens to be the 800 MHZ carrier frequency), one can take 0.1 sec to demodulate the BPSK 1 kbps signal using the derived carrier, and check for the pseudo-random Beacon PN code to verify that the binary packet is valid and contains valid data.

One can use any sort of error correction codes, such as forward error correction, to ensure that the TX packets are accurate. This is feasible, especially since Shannon's law shows that a data rate of 1 kbps in a 12.5 kHz bandwidth at fc=800 MHz will require a minimal SNR=>1/17, so the noise can be a maximum of 17 times larger than the signal and still reliably transmit the binary packets.

It is also important to note that the period T=1/f of our CW is:

T=1/f=1/fc=1.25 ns Note: Light travels 1 ft in 1 ns

One can integrate several periods of the CW (which happens be the carrier signal) over a 30 ns period, and have a 30 ft “error” or “bias” in the system. This is acceptable because all base stations will have this timing error, resulting in accurate distance measurements based on time difference of arrival (TDOA).

It is important to note that it is possible to account for these system “biases”:

1) 30 ns integration time before time stamp

2) Time to detect presence of CW preamble signal

One should try to use these known biases to refine the calculated/detected times, thereby increasing the location accuracy.

Base stations send the following information to the Command Center over modems:

User Id Number—useful if more than one user pushes the button;

TX Frame Number—used to avoid “cycle slip” packet comparison errors if a packet is missed;

Base Station Number—gives location through database lookup or GPS information; and

Binary Time Stamp—use for TDOA calculation.

Once 3-4 packets are received at a command center that all have the same user ID No. and TX Frame No., one can use the Base station Nos. and binary time stamp to determine the physical location of the RX (lookup database or decode GPS information sent in “Base Station No.” code word) and the time of signal acquisition. Using this data one can create a recursive algorithm that produces the person's physical location on a map based on geometrical TDOA hyperbola intersections.

If we assume that X number of base stations are needed to “cover” the campus, then the number of bits needed to satisfy 2ˆ n=X is:

n=log 2(X)

i.e. X=16 antennas

n=log 2(16)=4 bits

To apply this to our RX->CC (Command Center) packet:

Where:

SID=User ID Number=16 bits=65536

TXRX=TX Frame Number=8 bits=256

BS=Base Station Id=4 bits=16

BTS=Binary Time Stamp=8 bits=256

By utilizing established techniques in satellite telecommunications and modern modem transmission, one can ensure that system errors are minimized.

This Embodiment has Several Unique Features

The unmodulated 800 MHZ CW (carrier frequency) allows one to do accurate signal detection and time stamping. (T 800 Mhz=1.25 ns˜1 ft travel; one can therefore integrate a couple of these constant amplitude signal cycles, after passing them through a high bandwidth amp, over 30 ns and still have +−30 ft accuracy);

If one verifies the signal is present, we can “adjust” the time stamp back to account for the integration time or let the TDOA calculations ignore the relative system “bias” present at all the receivers, thereby making the system more accurate (one can use an adaptive algorithm to determine whether a “signal present” threshold has been passed.);

The modulated BPSK message signal allows us to accurately compare the time stamps derived from the CW portion.

The RX->CC link allows one to recreate the physical layout on the screen at the command center.

Additional Embodiments Contemplated for the BEACON Emergency Locator System:

Inexpensive Base Stations:

One embodiment is to have many inexpensive base stations positioned around campus. If the location of each of these base stations is known, an approximate location of a transmitter can be determined. This would be a good option for extending coverage indoors. For instance, in high rise buildings, base stations could be placed at each end of the hall on each floor. An optimal base station can be configured for each location and/or building. Either a wireline or wireless connection can be used to connect to base stations and a command center.

In another embodiment, a Beacon GPS device would have to act both as a receiver and a transmitter. First it will have to receiver ranging information from the GPS satellite constellation. Once, the GPS device has calculated its position it must transmit its location back to the network. Therefore the Beacon must be able to receive information at the GPS frequencies (in the 1.2 and 1.5 GHz range) and transmit location information to the network on whatever frequency that has been chosen.

Wireless LAN and Modem Embodiments:

Manufacturers of wireless LANs have a range of technologies to choose from when designing a wireless LAN solution. Wireless LANs use electromagnetic airwaves (radio or infrared) to communicate information from one point to another without relying on any physical connection. Radio waves are often referred to as radio carriers because they simply perform the function of delivering energy to a remote receiver. The data being transmitted is superimposed on the radio carrier so that it can be accurately extracted at the receiving end. Once data is superimposed (modulated) onto the radio carrier, the radio signal occupies more than a single frequency, since the frequency or bit rate of the modulating information adds to the carrier.

In a typical wireless LAN configuration, a transmitter/receiver (transceiver) device, called an access point, connects to the wired network from a fixed location using standard cabling. At a minimum, the access point receives, buffers, and transmits data between the wireless LAN and the wired network infrastructure. A single access point can support a small group of users and can function within a range of less than one hundred to several hundred feet. The access point (or the antenna attached to the access point) is usually mounted high but may be mounted essentially anywhere that is practical as long as the desired radio coverage is obtained.

Narrowband Technology: A narrowband radio system transmits and receives user information on a specific radio frequency. Narrowband radio keeps the radio signal frequency as narrow as possible just to pass the information. Undesirable crosstalk between communications channels is avoided by carefully coordinating different users on different channel frequencies. In a radio system, privacy and noninterference are accomplished by the use of separate radio frequencies. The radio receiver filters out all radio signals except the ones on its designated frequency.

Spread Spectrum Technology: Most wireless LAN systems use spread-spectrum technology, a wideband radio frequency technique developed by the military for use in reliable, secure, mission-critical communications systems. Spread-spectrum is designed to trade off bandwidth efficiency for reliability, integrity, and security. In other words, more bandwidth is consumed than in the case of narrowband transmission, but the tradeoff produces a signal that is, in effect, louder and thus easier to detect, provided that the receiver knows the parameters of the spread-spectrum signal being broadcast. If a receiver is not tuned to the right frequency, a spread-spectrum signal looks like background noise. There are two types of spread spectrum radio: frequency hopping and direct sequence.

Frequency-Hopping Spread Spectrum Technology: Frequency-hopping spread-spectrum (FHSS) uses a narrowband carrier that changes frequency in a pattern known to both transmitter and receiver. Properly synchronized, the net effect is to maintain a single logical channel. To an unintended receiver, FHSS appears to be short-duration impulse noise.

Direct-Sequence Spread Spectrum Technology: Direct-sequence spread-spectrum (DSSS) generates a redundant bit pattern for each bit to be transmitted. This bit pattern is called a chip (or chipping code). The longer the chip, the greater the probability that the original data can be recovered (and, of course, the more bandwidth required). Even if one or more bits in the chip are damaged during transmission, statistical techniques embedded in the radio can recover the original data without the need for retransmission. To an unintended receiver, DSSS appears as low-power wideband noise and is rejected (ignored) by most narrowband receivers.

Infrared Technology: A third technology, little used in commercial wireless LANs, is infrared. Infrared (IR) systems use very high frequencies, just below visible light in the electromagnetic spectrum, to carry data. Like light, IR cannot penetrate opaque objects; it is either directed (line-of-sight) or diffuse technology. Inexpensive directed systems provide very limited range (3 ft) and typically are used for personal area networks but occasionally are used in specific wireless LAN applications. High performance directed IR is impractical for mobile users and is therefore used only to implement fixed sub-networks. Diffuse (or reflective) IR wireless LAN systems do not require line-of-sight, but cells are limited to individual rooms.

Possible Wireless LAN Configurations:

Wireless LANs can be simple or complex. At its most basic, two PCS equipped with wireless adapter cards can set up an independent network whenever they are within range of one another. This is called a peer-to-peer network. On-demand networks require no administration or preconfiguration. In this case each client would only have access to the resources of the other client and not to a central server.

Installing an access point can extend the range of an ad hoc network, effectively doubling the range at which the devices can communicate. Since the access point is connected to the wired network each client would have access to server resources as well as to other clients. Each access point can accommodate many clients; the specific number depends on the number and nature of the transmissions involved. Many real-world applications exist where a single access point services from 15-50 client devices.

Access points have a finite range, on the order of 500 feet indoor and 1000 feet outdoors. In a very large facility such as a warehouse, or on a college campus it will probably be necessary to install more than one access point. Access point positioning is accomplished by means of a site survey. The goal is blanket the coverage area with overlapping coverage cells so clients might range throughout the area without losing network contact. The ability of clients to move seamlessly among a cluster of access points is called roaming. Access points hand the client off from one to another in a way that is invisible to the client, ensuring unbroken connectivity.

To solve particular problems of topology, the network designer might choose to use Extension Points to augment the network of access points. Extension Points look and function like access points, but they are not tethered to the wired network as are Access Points. Extension Points extend the range of the network by relaying signals from a client to an Access Point or another Extension Point. Extension Points may be strung together in order to pass along messaging from an Access Point to far-flung clients.

One last item of wireless LAN equipment to consider is the directional antenna. Suppose a wireless LAN is in a building A and it is desirable to extend it to a leased building, B, one mile away. One solution would be to install a directional antenna on each building, each antenna targeting the other. The antenna on A is connected to your wired network via an access point. The antenna on B is similarly connected to an access point in that building, which enables wireless LAN connectivity in that facility.

Advantages Using Wireless LAN:

Throughput: As with wired LAN systems, actual throughput in wireless LANs is product-and set-up-dependent. Factors that affect throughput include the number of users, propagation factors such as range and multipath, the type of wireless LAN system used, as well as the latency and bottlenecks on the wired portions of the LAN. Data rates for the most widespread commercial wireless LANs are in the 1.6 Mbps range. As a point of comparison, it is worth noting that state-of-the-art V.90 modems transmit and receive at optimal data rates of 56.6 Kbps. In terms of throughput, a wireless LAN operating at 1.6 Mbps is almost thirty times faster.

Licensing Issues: In the United States, the Federal Communications Commission (FCC) governs radio transmissions, including those employed in wireless LANs. Wireless LANs are typically designed to operate in portions of the radio spectrum where the FCC does not require the end-user to purchase license to use the airwaves. In the U.S. most wireless LANs broadcast over one of the ISM (Instrumentation, Scientific, and Medical) bands. These include 902-928 MHZ, 2.4-2.483 GHz, 5.15-5.35 GHz, and 5.725-5.875 GHz.

Safety: The output power of wireless LAN systems is very low, much less than that of a hand-held cellular phone. Since radio waves fade rapidly over distance, very little exposure to RF energy is provided to those in the area of a wireless LAN system. Wireless LANs must meet stringent government and industry regulations for safety. No adverse health affects have ever been attributed to Wireless LANs.

Security: Because wireless technology has roots in military applications, security has long been a design criterion for wireless devices. Security provisions are typically built into wireless LANs, making them more secure than most wired LANs. It is extremely difficult for unintended receivers (eavesdroppers) to listen in on wireless LAN traffic. Complex encryption techniques make it impossible for all but the most sophisticated to gain unauthorized access to network traffic. In general, individual nodes must be security-enabled before they are allowed to participate in network traffic.

Installation Speed and Simplicity: Installing a wireless LAN-system can be fast and easy and can eliminate the need to pull cable through walls and ceilings.

Installation Flexibility: Wireless technology allows the network to go where wire cannot go.

Scalability: Wireless LAN systems can be configured in a variety of topologies to meet the needs of specific applications and installations.

Types of Modem Connection:

When a base station receiver receives a radio signal from a BEACON transmitter, the modem located on the base station will initiate a call to the command center and establish a Point to Point connection and then transmit the packets for processing.

Modem connections may be either permanent connections or on-demand connection. There are advantages for each. For permanent connections, an equivalent number of modems is needed at the Command Center. A point-to-point modem connection is established between the individual base station and the command center. On-demand connections do not require that the exact number of modems installed at the command center equal the number of base stations on campus. The advantage of using a permanent connection is mainly to save time. The advantage for on-demand Connections is mainly to save cost, by not installing equivalent number of modems as compared to base stations on campus.

Location Finding and Information Processing

Global Positioning System and Time Stamp

The Global Positioning System (GPS) is a space-based radio positioning system that provides three-dimensional position, velocity and time information to suitably equipped users anywhere on or near the surface of the Earth. The system consists of a constellation of space satellites that transmit signals, a network of ground facilities for satellite monitoring, tracking and controlling, and passive user receivers that convert satellite signals to position and navigation information. The space segment consists of 24 satellites in 6 inclined orbital planes of 12 hour periods. The satellites transmit carrier signals at intervals of thirty seconds imbedded with time-tagged data. The receivers use this data to calculate pseudo-ranges based on propagation delay of the signals from the satellites. This procedure requires accurate time correlation between satellites and receivers, and adaptive error correction techniques to compensate for uncorrelated time and induced error.

The range from each satellite is determined by using a repeating pseudo-random noise (PRN) code that is a noise-like, but predetermined, unique series of bits. The PRN codes are modulated onto microwave carrier signals at different frequencies. The L1 frequency (1575.42 MHZ) carries messages used for navigation and the L2 frequency (1227.60 MHZ) is used to measure the ionosphere delay. The atomic clocks aboard the satellites produce the fundamental L-band frequency, 10.23 MHZ. The L1 and L2 carrier frequencies are generated by multiplying the fundamental frequency by 154 and 120, respectively. The noise-like codes spread the spectrum of the signal over a MHZ bandwidth making the transmitted signal less susceptible to jamming. The Coarse Acquisition code (C/A code), modulated on the L1 carrier, is the PRN code that contains the data frames used for range measurements.

The range measurements, called pseudo ranges because of the inaccuracy in the receiver's clock, are derived from measured travel times of the signal from each satellite to the receiver. The GPS navigation message consists of time-tagged data bits marking the time of transmission of each subframe from the satellite. A data frame, consisting of three six-second subframes, is transmitted every thirty seconds containing orbital and clock data.

To descramble the signal, the receiver must generate a copy of the satellite's PRN code. The copy is then correlated with the incoming signal at the correct offset to allow for propagation delay, which is found empirically. This procedure is implemented in the receiver using a shift register that slides a replica of the code in time until there is a correlation with the satellite code. As the satellite and receiver codes lineup completely, the spread-spectrum carrier is de-spread and full signal power is detected. The receiver's PRN code start position at the time of full correlation is the time of arrival (TOA) of the satellite's PRN code at the receiver. This TOA is a measure of the range to the satellite, offset by the amount to which the receiver clock is offset from the satellites' atomic clocks. The offset and the data from the PRN code are used to calculate the satellite's position and the position of the receiver. For the receiver's position, a matrix of four simultaneous equations must be solved iteratively.

Position of receivers are determined from multiple pseudo-range measurements using a resection method commonly referred to as triangulation.

A measurement of range from a particular satellite places the receiver on the surface of a sphere with center located at the satellite's position. Range measurement from an additional satellite defines a second sphere intersecting the first and creating a region of possible receiver positions. A third range measurement provides an intersection of two points common to all three spheres. Only one point is a viable position of the receivers longitude, latitude and altitude. Because the transmit time and the receive time are different, it is impossible to measure the true range between the satellite and the receiver with only three TOAs. Four satellites are used to determine three position dimensions and time offsets. Position dimensions are computed by the receiver in earth-centered, earth-fixed X, Y, Z coordinates. The simultaneous equations for receiver position are:

ρ(i)={square root over ((X−x(i))²+(Y−y(i))²+(Z−z(i))²−cdT(i))};i=1,2,3,4

where X, Y and Z are the coordinates of the receiver position; x(i),y(i) and z(i) are the coordinates of the respective satellite positions; and cdT(i) is the distance added caused by the receiver's clock offset.

Accurate position measurements require precise time correlation between the satellite and the receiver. The Global Positioning System places this responsibility on the satellites. Satellite time is maintained by each satellite using four onboard atomic clocks (two cesium and two rubidium). Satellite clocks are monitored by ground stations and occasionally reset to maintain time to within one-millisecond of GPS time. The imperfect receiver's time is set by the satellite transmitted signal, allowing for inexpensive receiver clocks. Clock correction data bits in the C/A code reflect the offset of each satellite from the receiver's clock. Data bit subframes occur every six seconds and contain bits that resolve the “Time of Week” to within six seconds. The data bit stream (50 Hz) is aligned with the C/A code transitions so that the arrival time of a data bit edge resolves the pseudo-range to the nearest millisecond.

In addition to accurate time correlation, knowledge of satellite position at any time instance is required for proper receiver positioning. Orbital information, called satellite ephemeris, is transmitted by the satellite as part of the broadcast message. Fixed ground control stations compute the satellite ephemeris and transmits the any ephemeride correction to the corresponding satellite. The fixed nature of the control station permits pseudo-range calculations to provide satellite positions. Using an orbital angular parameter called “anomaly,” the instantaneous position of the satellite within its orbit can be calculated.

GPS errors are a combination of noise and bias. Noise errors are the combined effect of PRN code noise and noise with the receiver. The PRN code noise is a result of additive white noise in the transmission channel, or atmospheric noise. The receiver noise is a function of the fidelity of the components used in the design of the individual receiver. These errors can be compensated by utilizing high-order filters to minimize noise at the carrier frequency. The more robust receivers provide greater percent of accuracy in position finding algorithms.

Bias of the pseudo-ranges is caused by environmental influences and geometric satellite positioning. Atmospheric layers alter the satellite signal when the “radio waves pass through the earth's charged ionosphere and water-laden troposphere.” This equates into an error in the distance calculations. To minimize this error, modeling of the atmospheric conditions are used to predict typical delay biases.

Error caused by “Geometric Dilution of Precision” (GDOP) magnifies other errors in the location finding algorithm. If a receiver's satellite signals are from satellites located in close orbital paths then an increase in a real point resolution is experienced. This increases the error margin around a position. The more sophisticated receivers determine which satellite signal to apply to the location finding algorithm and in effect minimize GDOP.

In addition to these natural occurring errors, the Department of Defense intentionally degrades the Global Positioning System's accuracy by introducing a clock offset and satellite position offset from the true values. This policy is known as “Selective Availability” (SA ) and is used to ensure that GPS signals are not used to guide accurate weapons directed at the United States. The civilian GPS receivers can generally calculate location to within 100 meters. Military receivers are believed to be accurate to within about 20 meters. Military receivers contain Auxiliary Output Chips (AOC) that allow decryption of accurate positioning codes.

In conclusion, the Global Positioning System combines satellite technology with precision digital signal processing algorithms to provide receiver-side low cost solution to navigation.

There are many different location technologies that can be used to determine the location of a transmitter.

Angle of Arrival

The idea behind an angle of arrival system is the use the differences in phase of arriving signals to calculate the angle at which the signal arrived. This can be combined with angles from another base station to calculate atransmitter's location. The advantages of an angle of arrival system. are:

Requires only angle of arrival measurements for two received signals to calculate location;

Only two base stations are necessary; and

Good for rural environments where there is greater separation of base stations.

Time of Arrival (TOA) and Time Difference of Arrival (TDOA)

TOA and TDOA are related to each other. With TOA the transmitters and network have synchronized clocks. Since they have synchronized clocks, it is easy to tell how long it took for signal to propagate from a handset to a base station. If the signal propagation time is known for three or more base stations, the transmitter's position can be calculated. TDOA is a little different. All of the base stations have synchronized clocks, but the transmitters do not have a synchronized clock. Each base station knows when a signal arrived based on the synchronized clock. These times are then processed by an algorithm at a command center to determine a transmitter's location.

Any ambiguity in the time at which the signal arrived at a particular site translates to position error. A simple calculation is explained to demonstrate this phenomenon. Light travels at 3′10⁸ m/s. Taking the inverse of this gives you the units of seconds per meter. This basically says that for every 3.3 nanoseconds of error translates to an error of a meter in position determination. If you take the inverse in feet per second rather than meters per second, you get 1.016′10⁻⁹ seconds per foot. So the basic rule of thumb it 1 nanosecond of error translates to 1 foot of error in position determination. These simple calculations demonstrate the importance of accurate timing in both the TOA and TDOA system. If timing off by 30 nanoseconds, the location uncertainty is 30 feet.

Radio Frequency Fingerprinting

Another technique being used for location determination is RF Fingerprinting. First a simulation of the environment is created. The simulations specifically look at the RF propagation characteristics, such as multipath phase and amplitude characteristics, in a specific environment. Next some field testing is done that records the propagation characteristics. This information is placed in a database where the propagation characteristics correspond to a specific location. When a signal arrives at a base station the propagation characteristics are recorded. This information is relayed to a central site where a database lookup takes place. The received propagation characteristics should correspond to a particular site. The advantages of this method are only one base station is needed for position determination, and line of sight is not needed. In fact multipath effects are exploited to determine position.

Power Detection

Another method to determine a transmitter's location is one based on signal attenuation. The farther away signal travels from its source the greater the attenuation. A propagation model can be used to estimate the user's location.

Handset Based Approaches

Another approach to finding a transmitter's location involves having the transmitter device tell a network where it is located.

Global Positioning System

GPS is a network of satellites that was deployed by the Department of Defense. These satellites send out ranging information that can be used to calculate someone's position anywhere on the globe. GPS has been used for military and maritime applications for years. It is quickly emerging as an option for E-911 applications.

A typical GPS receiver is the size of cell phone. It has an antenna, a display portion and some sort of user input mechanism like a keypad. When a user starts the GPS receiver, it first searches for satellite signals to lock onto. Next it takes in data for a period time. After it has sufficient data it performs the position calculation.

Conclusion

While various embodiments of the present invention have been described above, it should be understood that they have been presented by way of example only, not limitation. It will be understood by those skilled in the relevant art(s) that various changes in form and details may be made therein without departing from the spirit and scope of the invention as defined in the appended claims. thus, the breadth and scope of the present invention should not be limited by any of the above-described exemplary embodiments, but should only be defined in accordance with the following claims and their equivalents.

What is claimed is:

1. A method for providing transmitter location and personal identification information to a public safety answering point, comprising the steps of:
receiving at a base station at least one transmission packet signal having a transmitter identification number;
determining location dependent information which is representative of the location of the transmitter relative to the base station;
at each receiving base station, generating a base station packet that includes the transmitter identification number and the location dependent information; and
transmitting the base station packet to a command center.

2. The method of claim 1, wherein the step of generating location dependent information comprises the step of:
integrating said transmission packet signal to determine its power.

3. The method of claim 1, wherein the step of generating location dependent information comprises the step of:
generating a time stamp.

4. The method of claim 3, further comprising the steps of:
receiving said base station packet at said command center; and
processing said base station packet.

5. The method of claim 4, wherein the step of processing said base station packet comprises the steps of:
determining whether a valid base station packet was received;
determining said transmitter identification number; and
retrieving personal identification information based on said transmitter identification number.

6. The method of claim 5, wherein the step of retrieving personal identification information based on said transmitter identification number comprises the step of:
looking up said personal identification information in a data base that relates transmitter identification numbers and personal identification information.

7. The method of claim 5, further comprising the step of:
logging said base station packet data.

8. The method of claim 7, further comprising the step of:
determining a base station closest to a transmitter.

9. The method of claim 8, wherein the step of determining a base station closest to a transmitter comprises the step of:
sorting base station identification data taken from at least two said base station packets, wherein each of said base station packets is from a different base station.

10. The method of claim 8, further comprising the step of:
displaying personal identification information and location information based on said base station packet.

11. A system for providing location and personal identification information to a public safety answering point, comprising:
a base station for receiving a transmission packet signal having a transmitter identification number, said base station comprising,
a signal receiving unit for receiving said transmission packet signal; and
a signal processing unit for processing said transmission packet signal and generating a base station packet having said transmitter identification number and location information for transmission to a command center.

12. The system of claim 11, wherein said signal processing unit comprises:
a microprocessor.

13. The system of claim 11, wherein said signal processing unit comprises:
a unit for integrating said transmission packet signal to determine its power.

14. The system of claim 11, wherein said signal processing unit comprises:
a unit for generating a time stamp.

15. The system of claim 14, further comprising:
a unit for receiving said base station packet at said command center; and
a unit for processing said base station packet.

16. The system of claim 15, wherein said unit for processing said base station packet comprises a microprocessor running a software application that determines whether a valid base station packet was received, determines said transmitter identification number, and retrieves personal identification information based on said transmitter identification number.

17. The system of claim 16, further comprising:
a data base stored on a memory device, said data base having personal identification information retrievable by said transmitter identification number.

18. The system of claim 15, wherein said unit for receiving said base station packet at said command center comprises a modem.

19. The system of claim 18, further comprising:
a display for displaying personal identification information and location information based on said base station packet.

20. The system of claim 19, further comprising:
a transmitter for sending a transmission packet signal having a transmitter identification number.

21. The system of claim 11, wherin said base station is located in a vehicle.

22. A campus security system for providing location and personal identification information to a public safety answering point, comprising:
at least one handset for sending a transmission packet signal;
at least one base station for receiving said transmission packet signal and generating a respective base station packet for transmition; and
a command center for receiving and processing each base station packet, said command center being in communication with said plurality of base stations via one or more communication links.

23. The system of claim 22, wherein each handset comprises:
a micro-controller for storing a handset number;
a transmission unit for generating said transmission packet signal, said transmission packet signal having said handset number; and
an antenna for transmitting said transmission packet signal.

24. The system of claim 22, wherein each base station comprises:
an antenna for receiving said transmission packet signal;
a signal receiving unit for recovering said handset number from said transmission packet signal;
a signal processing unit for processing said handset number and generating said base station packet for transmission to said command center, said base station packet having said handset number and location information.

25. The system of claim 24, wherein said signal processing unit comprises:
a signal integration unit;
a binary time stamp unit; and
a microprocessor in communication with said signal integration unit and said binary time stamp unit.

26. The system of claim 22, wherein said command center comprises:
a microprocessor;
a secondary memory device having a database that associates said handset numbers with personal indentification information; said secondary memory device electrically connected to said microprocessor;
an application program for retrieving personal information from said data base using said handset numbers, said application program running on said microprocessor; and
a display for displaying retrieved personal information, said display electrically connected to said microprocessor.

27. The system of claim 22, wherein said one or more communication links comprise a plurality of telephone lines.

28. The system of claim 22, wherin said base station is located in a vehicle.

29. A mobile security system for providing location and personal identification information, comprising:
a base station for receiving a transmission packet signal and generating a base station packet for transmission; and
a command center for receiving and processing said base station packet, said command center being in communication with said base stations via one or more communication links.

30. The mobile security system of claim 29, wherein said command center comprises a microprocessor.

31. The mobile security system of claim 29, further comprising:
a plurality of handsets for sending respective transmission packet signals.
